(19) United States
(12) Patent Application Publication
(10) Pub. No.: US 2022/0413128 A1
(43) Pub. Date: Dec. 29, 2022

(54) GUIDANCE SYSTEM FOR LEADING AN AIRCRAFT TO A REFERENCE POINT; ASSOCIATED GUIDANCE METHOD

(71) Applicant: THALES, Courbevoie (FR)

(72) Inventors: Thierry MAZEAU, Merignac (FR); Charline CASTAING, Merignac (FR); Patrick GARREC, Pessac (FR)

(21) Appl. No.: 17/779,469

(22) PCT Filed: Nov. 26, 2020
(86) PCT No.: PCT/EP2020/083465

§ 371 Date: May 24, 2022

(30) Foreign Application Priority Data
Nov. 27, 2019 (FR) 1913300

(51) Int. Cl. G01S 13/91; G01S 13/48; G01S 13/87; G08G 5/02

(52) U.S. Cl. CPC G01S 13/913; G01S 13/48; G01S 13/878; G08G 5/025

(57) ABSTRACT

The invention relates to a guidance system for leading an aircraft to a reference point, characterised in that it comprises: An active beacon capable of emitting a first electromagnetic signal in a first emission cone, defined by an apex coinciding with the reference point, a first beam angle and a first axis corresponding to an emission direction; and a multi-beam radar, installed on board the aircraft, operating in reception mode and capable of performing deviation measurements on a signal received from the active beacon, the multi-beam radar comprising an antenna adapted for receiving in at least two spatially separate reception cones.

### CROSS-REFERENCE TO RELATED APPLICATIONS

The present Application for Patent is a National Stage Entry of International Application No. PCT/EP2020/083465, filed Nov. 26, 2020, which claims priority to French Patent Application No. 19 13300, filed Nov. 27, 2019. The disclosures of the priority applications are incorporated in their entirety by reference therein.

### FIELD OF THE INVENTION

The invention relates to the field of devices and methods for guiding an aircraft to a reference point.

### BACKGROUND

It would be desirable to have means of guiding an aircraft to a reference point in order to approach that point as closely as possible, i.e. with a guidance accuracy on the order of ten centimetres, preferably of the order of ten millimetres.

Such precision is required, for example, for the landing of a small helicopter on the deck of a ship, in particular an autonomous helicopter of the drone type.

Radio navigation systems are known, for example for maritime navigation, which use a plurality of emitting buoys whose geographical positions are known. A receiver on board a ship then determines from the signals received the distance to each buoy and, by triangulation, determines the absolute location of the ship.

In a variant of these systems, the location of the vessel is determined by measuring a phase difference between synchronised signals from different buoys.

However, the accuracy of these systems, which is adjusted to the needs of maritime navigation, is only on the order of a metre.

Instrument Landing Systems (ILS) are also known, which consist of beacons positioned on a runway to provide information about the direction of landing of the aircraft relative to the runway. Such a system guides a landing aircraft to land along the runway centreline with a controlled incidence. Such a system is not suitable for leading an aircraft to a reference point with high accuracy.

An alternative to ILS systems is presented in FR 2 894 347 and FR 2 878 336. A ground-based detection and location device uses a wave emitted by a emitter on board the aircraft to locate the aircraft to improve the accuracy of the aircraft's angular position measurement relative to the runway.

The aim of the present invention is therefore to meet this need by offering an alternative to known systems.

### SUMMARY

The object of the invention is therefore a guidance system for leading an aircraft towards a reference point, characterised in that it comprises: An active beacon capable of emitting a first electromagnetic signal in a first emission cone, defined by an apex coinciding with the reference point, a first beam angle and a first axis corresponding to an emission direction; and a multi-beam radar, carried on board the aircraft, operating in reception mode and capable of performing deviation measurements on a signal received from the active beacon, the multi-beam radar comprising an antenna adapted for receiving in at least two spatially separate reception cones.

The invention makes advantageous use of the principle of deviation measurement, which is also known in the field of radar for target tracking.

According to particular embodiments, the guidance system comprises one or more of the following features taken in isolation or in any combination that is technically possible:
the active beacon is able to further emit at least a second electromagnetic signal in a second emission cone, the apex of the second emission cone coinciding with the reference point, the axis of the second emission cone coinciding with the direction of emission, and a second beam angle, the second beam angle being strictly greater than the first beam angle of the first emission cone, the second signal and the first signal being separable from each other according to a predefined property, the multi-beam radar being suitable for separating, within the signal received from the active beacon, a contribution of the first signal and a contribution of the second signal, and for performing deviation measurements on the basis of the contribution of the first signal and/or the contribution of the second signal.
the predefined property being a frequency, the active beacon is suitable for emitting the first signal at a first characteristic frequency and the second signal at a second characteristic frequency, the second frequency being different from the first.
the multi-beam radar has a so-called parallel configuration in which the axes of the reception cones are parallel to each other, or a so-called divergent configuration in which the axes of the reception cones diverge from a centre of the radar antenna.
the multi-beam radar antenna has four elementary antennas, each elementary antenna being associated with a reception cone.

The invention also relates to a guidance method for leading an aircraft towards a reference point, using a guidance system in accordance with the preceding guidance system, consisting, in a landing phase, of bringing the aircraft closer to the reference point along the direction of emission of the active beacon, by monitoring a position of the aircraft in a plane perpendicular to the direction of emission as a function of deviation measurements made periodically by the multi-beam radar from the electromagnetic signal received from the active beacon.

According to particular embodiments, the guidance method comprises one or more of the following features taken in isolation or in any combination that is technically possible:
when, in the landing phase, the distance between the aircraft and the reference point is less than a limit altitude characteristic of the first emission cone of the active beacon and the deviation measurements can no longer be performed using the first electromagnetic signal emitted by the active beacon, the landing phase is continued by performing the deviation measurements using the second electromagnetic signal emitted by the active beacon in the second emission cone.
in an approach phase, the method consists of bringing the aircraft closer to the direction of emission of the active beacon in a plane substantially perpendicular to the direction of emission, by periodically performing deviation measurements.
in the approach phase, the deviation measurements are performed on the second signal emitted in the second emission cone, then, when the deviation measurements on the second signal are no longer relevant, the deviation measurements are performed on the first signal emitted in the first emission cone.

The invention further relates to an aircraft, characterised in that it carries either a multi-beam radar or an active beacon of a guidance system in accordance with the preceding guidance system.

### BRIEF DESCRIPTION OF THE DRAWINGS

The invention and its advantages will be better understood upon reading the following description of a particular embodiment, given only as a non-limiting example, that description being with reference to the attached drawings, in which:

FIG. 1 is a schematic representation of the landing of an aircraft on a runway using a guidance system according to the invention, which comprises an active beacon marking the runway centre and a multi-beam radar on board the aircraft;

FIG. 2 is a schematic representation of one embodiment of the active beacon of FIG. 1.

FIG. 3 is a schematic representation of one embodiment of the multi-beam radar of FIG. 1.

FIGS. 4 and 5 are geometrical representations to explain the deviation measurements performed by a multi-beam radar from the signal emitted by an active beacon;

FIG. 6 is an illustration of an approach phase of the guidance method according to the invention, which positions the multi-beam radar in line with the active beacon; and

FIG. 7 is an illustration of a landing phase of the guidance method according to the invention, which brings the multi-beam radar closer to the active beacon.

### DETAILED DESCRIPTION

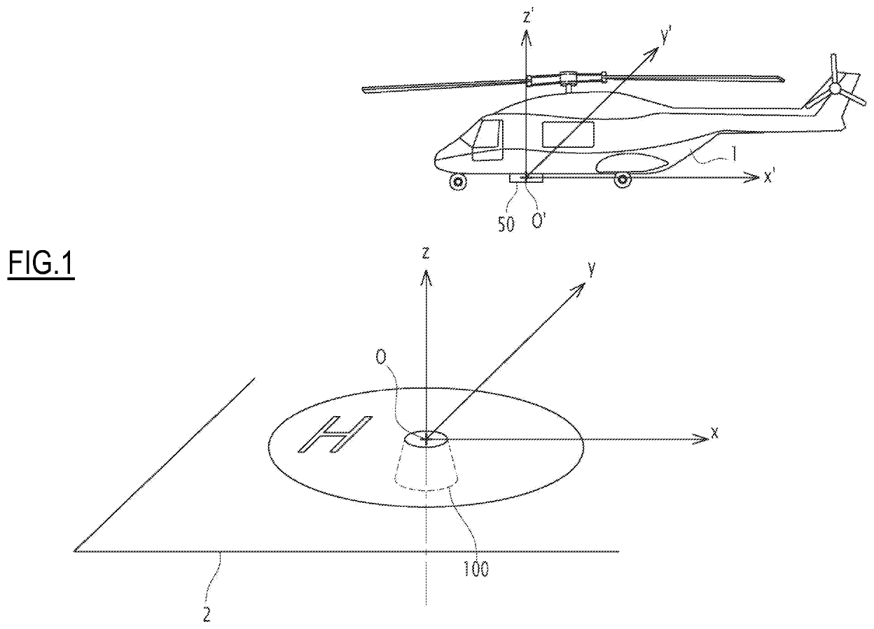

Referring to FIG. 1, a guidance system is used when landing an aircraft 1 on a runway 2, so as to bring the aircraft 1 to a reference point O with high accuracy.

A reference frame (O, X Y Z) is associated with the runway 2 so that its origin coincides with the reference point O. The plane of the runway 2 is defined by the X and Y axes, while the direction perpendicular to the runway 2 corresponds to the Z axis, which is considered here as vertical.

The guidance system comprises an active beacon 100 and a multi-beam radar 50.

The active beacon 100 is used to mark the reference point O. The active beacon 100 is located in the runway 2, for example.

The multi-beam radar 50 is carried on board the aircraft 1. The multi-beam radar 50 is for example fixed with respect to the aircraft 1.

A reference frame (O′, X′ Y′ Z′ is associated with the multi-beam radar 50. To simplify the present description, once the aircraft has landed on runway 2 in the desired position, the reference frame (O′, X′ Y′ Z′) coincides with the reference frame (O, X Y Z).

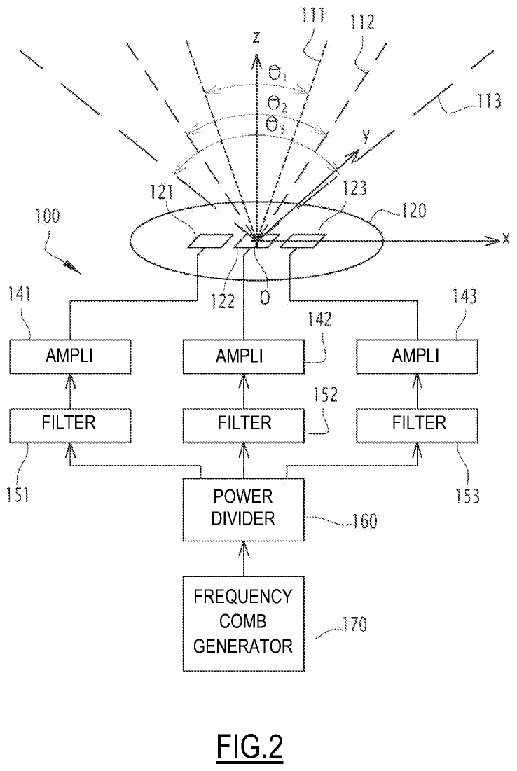

As shown in FIG. 2, the active beacon 100 incorporates an antenna 120 with three radiating elements 121, 122 and 123.

Each radiating element is capable of emitting a characteristic electromagnetic signal in a substantially conical emission beam. The different emission beams have the same origin and a common axis. This common axis, or direction of emission of the active beacon, corresponds to the Z axis.

More precisely, the first radiating element 121 is suitable for emitting a first electromagnetic signal, at a first characteristic frequency f1, within a first emission cone 111. The first emission cone 111 is such that its apex coincides with the reference point O and its axis coincides with the Z axis. This first emission cone 111 is characterised by an beam angle θ₁.

The second radiating element 122 is suitable for emitting a second electromagnetic signal, at a second characteristic frequency f2, within a first emission cone 112. The second emission cone 112 is such that its apex coincides with the reference point O and its axis coincides with the Z axis. It is characterised by a second beam angle θ₂, strictly greater than the first beam angle θ₁.

The third radiating element 123 is suitable for emitting a third electromagnetic signal, at a third characteristic frequency F3, within a third emission cone 113. The third emission cone 113 is such that its apex coincides with the reference point O and its axis coincides with the Z axis. It is characterised by a third beam angle θ₃, strictly greater than the second beam angle θ₂.

Note that FIG. 2 is schematic. The distance between the radiating elements is small enough that the beams emitted by each of these radiating elements can be considered to be superimposed on each other.

The feed system of the antenna 120 incorporates a generator 170 capable of producing a feed signal of the frequency comb type: It comprises a first component at the first characteristic frequency f1, a second component at the second characteristic frequency f2, and a third component at the third characteristic frequency f3.

Downstream of the generator 170, a power divider 160, separates the feed signal into three identical elementary feed signals.

Each elementary feed signal is applied to the input of a feed line, the output of which is connected to an associated radiator.

Each feeder has a filter followed by an amplifier to shape the excitation signal of the associated radiator.

More precisely, the first filter 151 allows the first component of frequency f1 to be selected from the elementary feed signal. This is amplified by the amplifier 141 before being applied to the first radiating element 121.

The second filter 152 allows the second component of frequency f2 to be selected from the elementary feed signal. This is amplified by the amplifier 142 before being applied to the second radiating element 122.

The third filter 153 allows the third component of frequency f3 to be selected from the elementary feed signal. This is amplified by the amplifier 143 before being applied to the third radiating element 123.

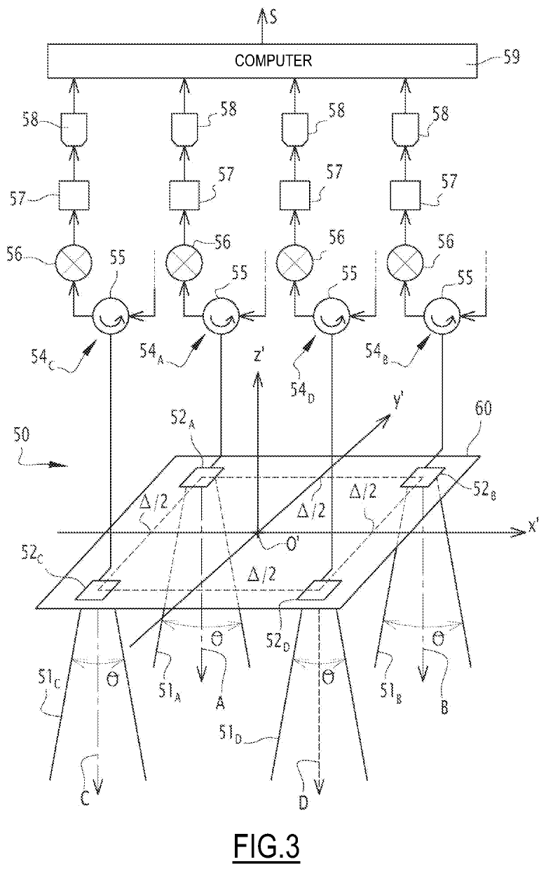

Referring to FIG. 3, the multi-beam radar 50 incorporates an antenna 60. The antenna plane of the antenna 60 corresponds to the plane X′Y′ and its geometrical centre to the origin O′.

The antenna 60 comprises for example four elementary antennas, each elementary antenna being suitable for receiving electromagnetic signals in a conical reception beam.

More specifically, in the embodiment shown in FIG. 2, the installation points of the elementary antennas on the antenna plane correspond to the vertices of a square with centre O′ and side length Δ.

The antenna element 52_{A}, 52_{B}, 52_{C} and 52_{D} collects the signals in an A-axis reception cone 51_{A}, a B-axis reception cone 51_{B}, a C-axis reception cone 51_{C} and a D-axis reception cone 51_{D}.

The axes of the reception cones are parallel to each other and to the Z′ axis. They are, however, separate from the Z′ axis and oriented towards the negative values in order to be able to pick up the signal emitted by the active beacon 100.

The different reception cones have the same beam angle θ.

The multi-beam radar 50 is for example an emit/receive radar, which is not dedicated to guidance, but can be used to perform other tasks during the flight of the aircraft 1. However, when the multi-beam radar 50 is used for guidance, it only serves to receive.

Thus, the multi-beam radar 50 has four identical emit/receive channels, 54_{A}, 54_{B}, 54_{C} and 54_{D} respectively. Each channel is associated with one of the elementary antennas.

Each channel has an emit line and a receive line connected to the associated elementary antenna via a circulator 55.

The emit line is not depicted in more detail as it is not used for guidance.

A receive line receives as input the signal collected by the corresponding elementary antenna. It integrates in a traditional way:

a frequency mixer 56 for converting the signal into a baseband, which is characterised by an intermediate frequency;

an amplification and filtering unit 57 for isolating the wanted signal within the baseband; and,

an analogue-to-digital converter 58 for coding the filtered signal.

The digitised signal at the output of each receive line is applied to the input of a computer 59.

The computer 59 is suitably programmed to periodically take deviation measurements and generate a guidance signal S as an output.

The pilot of the aircraft 1 is made aware of the guidance signal S, for example by means of a suitable human-machine interface, so that the pilot can take it into account in the way they manoeuvre the aircraft during the landing. Alternatively, the guidance signal S is emitted to an autopilot device for automatic landing of the aircraft 1.

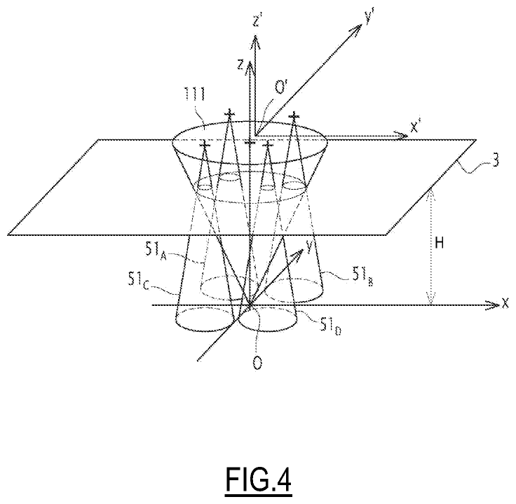

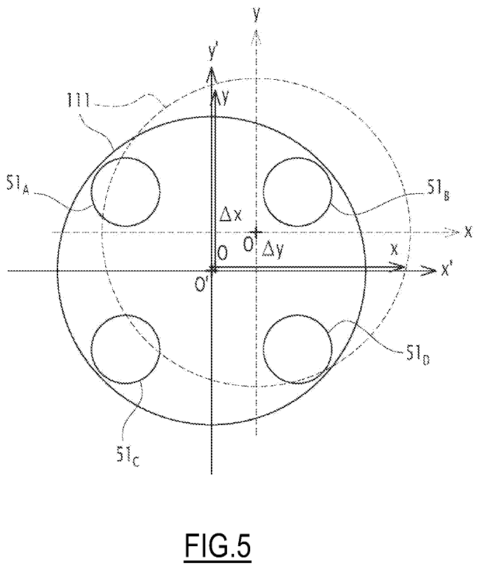

The principle of the deviation measurements performed by the computer 59 is illustrated in FIGS. 4 and 5, for the particular case where only one emission cone is considered, for example the first emission cone 111.

The situation shown in FIG. 4 corresponds to the case where the multi-beam radar 50 is located directly above the active beacon 100 (the Z′ axis coinciding with the Z axis). In addition, the antenna plane X′Y′ is parallel to the plane XY of runway 2.

Shown are the first emission cone 111 of the beacon 100 and the four reception cones 51_{A}, 51_{B}, 51_{C} and 51_{D} of the radar 50.

FIG. 5 shows a section of these different cones along an intermediate plane 3 parallel to the plane XY of the runway 2. The intermediate plane 3 is integral with the aircraft 1, i.e. the distance between the intermediate plane 3 and the plane X′Y′ is constant.

The intersection of a cone with the intermediate plane 3 is along a circle. When the altitude of the aircraft 1 is high, the sections of the reception cones 51_{A}, 51_{B}, 51_{C} and 51_{D} lie within the section of the emission cone 111.

As the altitude of the aircraft 1 decreases, i.e. as the radar 50 approaches the active beacon 100, the cross-sectional diameter of the emission cone 111 gradually decreases.

Around a limit altitude H₁, the cross-section of the emission cone 111 is tangent to the various cross-sections of the reception cones 51_{A}, 51_{B}, 51_{C} and 51_{D}. This is shown in solid lines in FIG. 5.

As the altitude of the aircraft 1 continues to decrease, the diameter of the section of the emission cone 111 reduces so that the receive cone sections 51_{A}, 51_{B}, 51_{C} and 51_{D} eventually emerge and are outside the perimeter of the section of the emission cone 111.

For altitudes above the Hi limit, deviation measurements are used to align the aircraft's Z′ axis with the beacon's Z axis.

As illustrated in FIG. 5 in dotted lines for the case of the limit altitude H₁, as soon as the Z′ axis of the radar is no longer aligned with the Z axis of the beacon, the section of the emission cone 111 is shifted with respect to the reference frame (O′, X′ Y′), so that all or part of some of the sections of the reception cones 51_{A}, 51_{B}, 51_{C} and 51_{D} leave the perimeter of the section of the emission cone 111. There is then a difference between the amplitude of the signals picked up by each of the elementary antennas of the radar 50. The determination of this difference allows an assessment of the misalignment of the Z and Z′ axes.

The computer 59 is thus able to periodically calculate the quantities:

δ_{X}=(|A|+|C|)−(|B|+|D|)

δ_{Y}=(|A|+|B|)−(|C|+|D|)

Σ=|A|+|B|+|C|+|D|

Where |A|, |B|, |C| and |D| are the amplitudes of the signals picked up by the elementary antennas 51_{A}, 51_{B}, 51_{C} and 51_{D} respectively.

The ratio of the quantity δ_{X} to the quantity Σ is proportional to the deviation Δx between O′ and O along the X axis and the ratio of the quantity δ_{Y} to the quantity Σ is proportional to the deviation Δy between O′ and O along the Y axis.

Thus, the search, at each moment, for the minimum of each of these two ratios allows the aircraft 1 to be centred on the direction of emission of the active beacon 100.

The deviation measurements therefore allow the position of the aircraft 1 to be corrected to align the Z′ axis with the Z axis, while gradually reducing the altitude of the aircraft 1.

However, as indicated above, below the limit altitude H₁, it is no longer possible to perform deviation measurements from the first signal, as the elementary antennas of the radar 50 are no longer “illuminated” by the first conical beam of the beacon 100.

The limit altitude H₁ for the first emission cone 111 is given by the following relationship:

$$\frac{Δ / \sqrt{2}}{{H}_{1}} = tan ( {θ}_{1} / 2 )$$

Where Δ/\sqrt{2} is the distance from the centre of an elementary antenna to the point O′ in the antenna plane of the radar 50.

For a constant Δ, it can be seen that the beam angle of the emission cone must be increased to reduce the altitude limit.

This is taken into account in the currently preferred embodiment, in which the active beacon 100 emits signals in increasingly open emission cones.

Thus, as soon as the deviation measurements can no longer be performed by means of the first signal (the aircraft being at an altitude below the limit altitude H₁ associated with the first emission cone 111), they are performed by means of the second signal, emitted in a second emission cone 112 having a larger aperture than the first emission cone 111.

Likewise, as soon as the deviation measurements can no longer be performed by means of the second signal (the aircraft being at an altitude below the limit altitude H2 associated with the second emission cone 112), they are performed by means of the third signal, emitted in a third emission cone 113 having a larger aperture than the second emission cone 112.

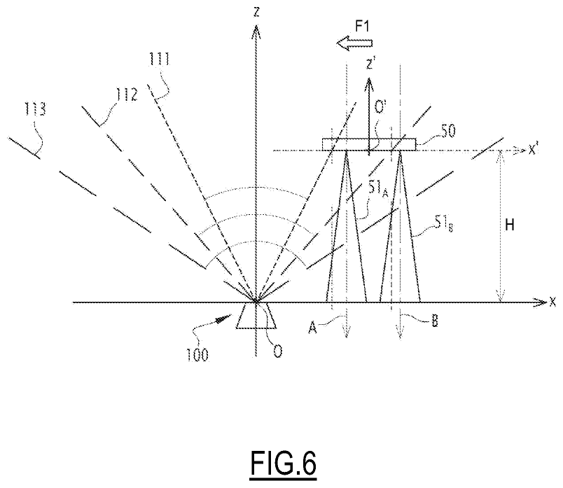

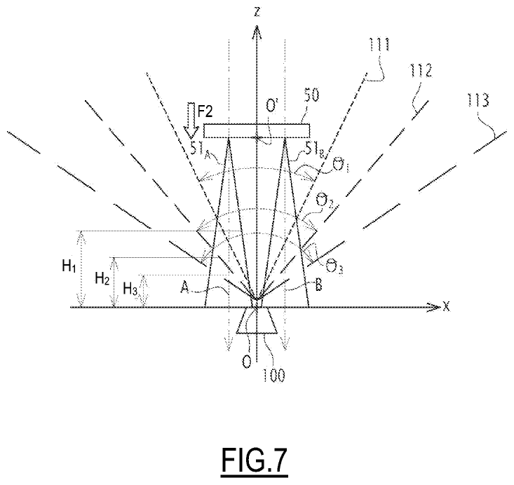

The guidance method according to the invention will now be described with reference to FIGS. 6 and 7, which are views in a vertical plane XZ.

At reference point O, the active beacon 100 simultaneously emits three signals, at different characteristic frequencies (f1, f2 and f3 respectively), in three coaxial emission cones originating from point O (111, 112 and 113 respectively).

FIG. 6 illustrates an approach phase of the guidance method which aligns the Z′ axis of the radar 50 with the Z axis of the beacon 100 by moving in the direction F1 of the aircraft 1.

In this approach phase, the aircraft 1 approaches the runway 2.

The radar 50 picks up the third signal emitted in the third emission cone 113, which has the largest aperture.

Using this third signal, the aircraft 1 is guided to approach the Z-axis of the third emission cone 113 at a substantially constant altitude.

As the radar 50 continues to move, it eventually picks up the second signal emitted in the second emission cone 112. From then on, the deviation measurements are no longer performed on the third signal (which would no longer be discriminating), but on the second signal.

The aircraft may continue to be guided, still at a substantially constant altitude, closer to the Z axis of the second emission cone 112.

As the radar 50 continues to move, it eventually picks up the first signal in the first cone 111, allowing the deviation measurements to be performed not on the second signal but on the first signal.

The aircraft 1 is thus gradually brought to the direction of emission of the active beacon 100, in line with the reference point O

FIG. 7 illustrates the next phase of the guidance method. This is the actual landing phase, allowing the aircraft 1 to approach the reference point O while maintaining alignment with the direction of emission of the active beacon 100. The aircraft moves in direction F2.

In this landing phase, the altitude of the aircraft 1 is gradually reduced while regulating the position of the aircraft transversely to the Z-axis using the deviation measurements performed from the first signal emitted in the first cone 111.

The aircraft 1 eventually reaches the limit altitude Hi associated with the first emission cone 111.

In order to be able to continue guiding the aircraft below the limit altitude H₁, the multi-beam radar 50 then uses the second signal emitted in the second emission cone 112 to perform the deviation measurements.

This allows the position of the aircraft along the Z-axis to be constrained until the limit altitude H₂ associated with the second emission cone 112 is reached.

In order to be able to bring the aircraft even closer to the reference point O, below the limit altitude H₂, the multi-beam radar 50 uses the third signal emitted in the third emission cone 113 to perform the deviation measurements.

This allows the aircraft to be guided along the Z-axis to the limit altitude H₃ associated with the third emission cone 113.

With the aircraft 1 in the vicinity of reference point O, simply shutting down the engine of the aircraft 1 will allow it to land on the runway 2 in the immediate vicinity of reference point O.

By correctly choosing the value of the beam angles of the emission cones, as well as the characteristic parameters of the multi-beam radar (in particular the distance between the elementary antennas), it is possible to guide the aircraft within a few millimetres of the reference point.

With these values, the system just described allows the landing of a small drone within 10 mm of the reference point O. This corresponds to the desired accuracy.

In general, the active beacon antenna has at least one emission cone. Having more emission cones improves the accuracy of guidance.

In one embodiment, the antenna comprises a single emission cone, the aperture of which is adjustable, in particular as a function of the distance separating the aircraft to be guided from the reference point.

Other architectures of the feed system of the antenna's radiating element(s) than the one described in FIG. 2 are known to the skilled person.

In general, the multi-beam radar comprises an antenna incorporating at least two elementary antennas, separated from each other along a separation direction. The guidance method then takes place in a plane defined by the emission axis of the active beacon and the separation direction of the radar.

In the embodiment shown above, the elementary antennas are spaced apart in the antenna plane and the axes of the reception cones are parallel to each other. As an alternative to this so-called parallel configuration, the multi-beam radar antenna is configured in such a way that the elementary antennas are close to each other in the antenna plane and the axes of the reception cones are divergent (divergent configuration).

Other architectures of the electronics associated with the multi-beam radar antenna than the one described in FIG. 3 are known to the skilled person.

Instead of the different signals emitted by the active beacon being characterised by a particular frequency, another property of the signal can be used to allow discrimination between each of the emitted signals. For example, each signal could be produced with a characteristic amplitude modulation, a characteristic phase modulation, a characteristic frequency modulation, or a characteristic polarisation (straight, left circular or right circular).

The different signals emitted by the active beacon can be emitted simultaneously or successively.

The electromagnetic signal emitted by the active beacon can be a signal in the infrared spectrum, in the optical spectrum, in the radio spectrum, or any other electromagnetic spectrum suitable for the application.

In another embodiment, the multi-beam radar marks the reference point and the active beacon is carried on board the aircraft. In order to guide the movement of the aircraft on the basis of the radar's deviation measurements, a communication link must be established between the radar and the aircraft so that the pilot and/or the aircraft's flight control system can receive the data required for guidance.

Aircraft means any type of aeroplane, helicopter, airship, or more generally any type of manoeuvrable flying machine.

1. A guidance system for guiding an aircraft to a reference point, the guidance system comprising:
an active beacon emitting a first electromagnetic signal in a first emission cone the first emission cone being, defined by an apex that coincides with the reference point, a first beam angle and a first axis that corresponds to an emission direction;
a multi-beam radar, carried on board the aircraft, operating in a reception mode and performing deviation measurements on a signal received from the active beacon, the multi-beam radar comprising an antenna receiving in at least two reception cones that are spatially separated.

2. The guidance system according to claim 1, wherein the active beacon emits a second electromagnetic signal in a second emission cone, an apex of the second emission cone coinciding with the reference point, an axis of the second emission cone coinciding with the direction of emission, and a second beam angle, the second beam angle being strictly greater than the first beam angle of the first emission cone, the second electromagnetic signal and the first electromagnetic signal being separable from each other according to a predefined property, the multi-beam radar separating, within the signal received from the active beacon, a contribution of the first electromagnetic signal and a contribution of the second electromagentic signal, and performing deviation measurements on the basis of the contribution of the first electromagnetic signal and/or the contribution of the second electromagnetic signal.

3. The guidance system according to claim 2, wherein, the predefined property being a frequency, the active beacon emits the first electromagnetic signal at a first characteristic frequency and the second electromagnetic signal at a second characteristic frequency, the second frequency being different from the first frequency.

4. The guidance system according to claim 1, wherein the multi-beam radar has a so-called parallel configuration, in which the axes of the reception cones are parallel to each other, or a so-called divergent configuration, in which the axes of the reception cones diverge from a centre of the antenna of the multi-beam radar.

5. The guidance system according to claim 1, wherein the antenna receiving in four reception cones, the antenna of the multi-beam radar comprises four elementary antennas, each elementary antenna being associated with one reception cone of the four reception cones.

6. A guidance method for leading an aircraft towards a reference point, using a guidance system in accordance with claim 1, further comprising, in a landing phase, of bringing the aircraft closer to the reference point along the direction of emission of the active beacon, by monitoring a position of the aircraft in a plane perpendicular to the direction of emission as a function of deviation measurements made periodically by the multi-beam radar from the signal received from the active beacon.

7. The guidance method according to claim 6, wherein, the guidance system being according to claim 2, when, in the landing phase, the distance between the aircraft and the reference point is less than a limit altitude characteristic of the first emission cone of the active beacon and the deviation measurements can no longer be performed from the first electromagnetic signal emitted by the active beacon in the first emission cone, the landing phase is continued by performing the deviation measurements on the basis of the second electromagnetic signal emitted by the active beacon in the second emission cone.

8. The guidance method according to claim 6, further comprising, in an approach phase, in bringing the aircraft closer to the direction of emission of the active beacon in a plane substantially perpendicular to the emission direction of emission, by periodically performing deviation measurements.

9. The guidance method according to claim 8, wherein, the guidance system being according to claim 2, in the approach phase, the deviation measurements are performed on the second electromagnetic signal emitted in the second emission cone, then, when the deviation measurements on the second electromagnetic signal are no longer relevant, the deviation measurements are performed on the first electromagnetic signal emitted in the first emission cone.

10. An aircraft wherein the aircraft carries either a multi-beam radar or an active beacon of a guidance system according to claim 1.
